(19) United States
(12) Patent Application Publication
(10) Pub. No.: US 2003/0169967 A1
(43) Pub. Date: Sep. 11, 2003

(54) Chromatic dispersion compensation in a broadband optical transmission system

(76) Inventors: Pierre Sillard, Le Chesnay (FR); Louis-Anne de Montmorillon, Paris (FR); Ludovic Fleury, Bois D'Arcy (FR); Pascale Nouchi, Maisons Laffitte (FR); Isabelle Riant, Orsay (FR); Jean-Pierre Hamaide, St Germain Les Arpajon (FR)

Correspondence Address: SUGHRUE MION, PLLC, 2100 PENNSYLVANIA AVENUE, N.W., WASHINGTON, DC, 20037, US

(21) Appl. No.: 10/311,807

(22) PCT Filed: Jun. 28, 2001
(86) PCT No.: PCT/FR01/02063

(30) Foreign Application Priority Data
Jun. 30, 2000 (FR) 00/08554

(51) Int. Cl. G02B 6/34

(52) U.S. Cl. 385/37

(57) ABSTRACT

The invention relates to compensating chromatic dispersion and chromatic dispersion slope in optical fiber transmission systems. It proposes using dispersion compensating fiber (12) and a plurality of Bragg gratings (15, 16, 17) for compensating chromatic dispersion in the transmission fiber (4ᵢ). Each Bragg grating presents a bandwidth that is greater than 25 nm, so as to enable the system to be used in broad bands. In addition, the absolute value of the compensation provided by each Bragg grating is less than 250 ps/nm, thus ensuring that the grating remains easy to manufacture in spite of its broad band. The invention applies in particular to very high data rate systems (above 40 Gbit/s for each channel), with a utilization band extending between 1250 nm to 1650 nm.

The present invention relates to the field of optical fiber transmission, and more specifically it relates to compensating chromatic dispersion and chromatic dispersion slope in optical fiber transmission systems.

In new high data rate and wavelength division multiplex (WDM) transmission networks, it is advantageous to manage chromatic dispersion, in particular at data rates greater than or equal to 10 Gbit/s. The purpose is to ensure that for all wavelengths of the multiplex, the accumulated chromatic dispersion over a link is substantially zero so as to limit pulse spreading. An accumulated value of a few tens of picoseconds per nanometer (ps/nm) for dispersion is acceptable. For this purpose, it is desirable to limit chromatic dispersion, and in order to be able to act on a plurality of channels, it is also desirable to limit chromatic dispersion slope. It is also advantageous to avoid having zero values of chromatic dispersion in the vicinity of the wavelengths used in the system since non-linear effects are greater at zero values. This problem of compensating chromatic dispersion and chromatic dispersion slope is particularly acute with very high data rate transmission systems, typically WDM transmission systems with a data rate per channel of 40 Gbit/s and above. The problem becomes more acute with increasing bandwidth, particularly for values greater than or equal to 25 nm.

It is conventional for the line fiber of an optical fiber transmission system to be a fiber having a step index (also known as a single-mode fiber (SMF)). The Applicant thus sells a single-mode fiber having a step index under the reference ASMF 200 for which the wavelength λ₀ at which chromatic dispersion becomes zero lies in the range 1300 nm to 1320 nm, and for which chromatic dispersion is less than 3.5 picoseconds per nanometer-kilometer (ps/(nm.km)) over the range 1285 nm to 1330 nm, and is equal to 17 ps/(nm.km) at 1550 nm. The chromatic dispersion slope at 1550 nm is about 0.06 ps/(nm².km).

Dispersion-shifted fibers (DSF) have also appeared on the market. These fibers are such that at the transmission wavelength at which they are used, which is generally different from the wavelength of 1.3 micrometers (μm) at which the dispersion of silica is substantially zero, the chromatic dispersion of the guided mode is substantially zero; i.e. the non-zero chromatic dispersion of the silica is compensated, hence the use of the term “shifted”, by increasing the index difference Δn between the core of the fiber and its cladding. This index difference enables the wavelength at which chromatic dispersion is zero to be shifted; it is achieved by introducing dopants into the preform during manufacture thereof, e.g. using a conventional modified chemical vapor deposition (MCVD) process which is not described in greater detail herein.

Non-zero dispersion-shifted fibers (NZ-DSF) are dispersion-shifted fibers which present non-zero chromatic dispersion at the wavelengths at which they are used. These fibers present, at these wavelengths, chromatic dispersion of small value, typically lying in the range 2 ps/(nm.km) to 14 ps/(nm.km) (for NZ-DSF+), or lying in the range −6 ps/(nm.km) to −2 ps/(nm.km) (for NZ-DSF−) at a wavelength of 1550 nm. The various NZ-DSF fibers that are presently available present a wide variety of slopes lying in the range 0.04 ps/(nm².km) to 0.12 ps/(nm².km). For example, the supplier Corning sells a fiber under the trademark LEAF which, at 1550 nm, presents chromatic dispersion of about 4 ps/(nm.km) and chromatic dispersion slope of about 0.08 ps/(nm².km) to 0.09 ps/(nm².km). The supplier Lucent sells a fiber under the trademark TrueWave which presents, at 1550 nm, chromatic dispersion of about 4 ps/(nm.km) and chromatic dispersion slope of about 0.045 ps/(nm².km). The Applicant sells a fiber under the trademark TeraLight which presents, at the same wavelength 1550 nm, chromatic dispersion of 8 ps/(nm.km) and chromatic dispersion slope of 0.058 ps/(nm².km).

To compensate chromatic dispersion and chromatic dispersion slope in SMF or NZ-DSF line fibers, it is known to use short lengths of dispersion compensating fiber (DCF). For a step index SMF, one example is given in “Large volume manufacturing of dispersion compensating fibers” by L. Grüner-Nielsen et al., OFC'98 Technical Digest TuD5.

That solution is more difficult to implement for NZ-DSF line fibers which present chromatic dispersion that is lower than for SMF line fibers. As a result, with such fibers, the ratio of chromatic dispersion to chromatic dispersion slope is smaller than it is for SMF, and it is more difficult to make a dispersion compensating fiber. Manufacturing tolerances are much tighter: the fiber is thus more difficult to make. In particular, it becomes more difficult to find an acceptable compromise between the various propagation characteristics: effective area, cutoff wavelength, bending losses. K. Mukasa et al. have proposed in “Novel network fiber to manage dispersion at 1.55 μm with combination of 1.3 μm zero dispersion single-mode fiber” published in ECOC 97, Sep. 22-25, 1997, Conference Publication No. 448, a reverse dispersion fiber (RDF) presenting chromatic dispersion properties and chromatic dispersion slope that are the inverse of those of an SMF line fiber. At 1550 nm, that fiber presents chromatic dispersion of −15.69 ps/(nm.km), and chromatic dispersion slope of −0.046 ps/(nm².km). In that publication, the RDF is used as a line fiber in alternation with the SMF: the chromatic dispersion and chromatic dispersion slope accumulated in an SMF section are compensated by propagation in the following RDF section.

As with the above-described DCF solutions, RDF solutions are difficult to implement when compensating NZ-DSF dispersion and slope.

In the text below, the term “dispersion compensating fiber” is used to designate a fiber implemented in a cable or a module to compensate the chromatic dispersion of an SMF or an NZ-DSF line fiber. In other words the term “dispersion compensating fiber” is being used generically to cover both the DCF and the RDF concepts as described in the above articles.

It is also known to use a Bragg grating for compensating chromatic dispersion and chromatic dispersion slope (R. I. Laming et al., “Dispersion compensating fiber Bragg gratings”, Proceedings WFOPC'98, University of Pavia, pp. 108-115). In this case, quadratic variation of pitch serves to compensate spectral dispersion slope (M. Ibsen et al., “Long continuously chirped fiber Bragg gratings for compensation of linear and third order dispersion”, ECOC'97, September 1997, pp. 49-52). The drawback of that type of solution is that the spectrum width covered is proportional to the ratio of the length of the photo-induced grating to the chromatic dispersion of the component, expressed in ps/nm. Thus, a grating having a length of 1 meter (m) induced so as to compensate chromatic dispersion and slope after 100 km of propagation of a signal emitted in band C (typically in the range 1530 nm to 1565 nm) in a LEAF® fiber of the above-mentioned type cannot have a passband of width greater than 25 nm. A passband having a maximum width of 13 nm applies to compensating chromatic dispersion and slope in the Applicant's TeraLight® fiber. These spectrum bandwidths are well below the widths of the following bands: S (typically 1460 nm to 1490 nm); C; or L (typically 1570 nm to 1610 nm). These bandwidths are close to 35 nm.

Research Disclosure No. 41909, “Hybrid dispersion compensating module” (published by Kenneth Mason Publications Ltd. in No. 419 in March 1999) relates to the problem of compensating dispersion in optical fiber transmission systems having a line fiber with positive dispersion; that document recommends not using a dispersion compensating fiber because of the high levels of loss and the expense of such fibers. That document thus recommends using Bragg gratings for compensating dispersion. The problem raised is then that of Bragg gratings being designed for a fixed value of chromatic dispersion and being difficult to adapt on site as a function of local variations in chromatic dispersion. That document thus proposes using a module constituted by a circulator, a section of dispersion compensating fiber, and a Bragg grating operating in reflection. The light passes through the circulator, the dispersion compensating fiber, is reflected by the Bragg grating, passes back through the dispersion compensating fiber, and then on into the circulator. The Bragg grating compensates the majority of the chromatic dispersion, thus making it possible to retain the advantages of a Bragg grating, in particular low insertion loss. The presence of a section of dispersion compensating fiber makes it easy to match the dispersion compensation module thus mitigating the fixed nature of the characteristics of the Bragg grating. That document does not provide a solution to the problem of bandwidth; the dispersion compensating fiber is used solely to match the Bragg grating.

The Japanese patent application laid open to public inspection under the No. JP-A-11 119 030 also proposes compensating chromatic dispersion in a transmission system using a combination of a compensating fiber and an induced grating. The induced grating may be constituted in particular by a Bragg grating operating in transmission or in reflection, or an inclined Bragg grating operating in transmission. The dispersion compensating fiber is used to compensate the chromatic dispersion of the line fiber; the induced grating is used for compensating the wavelength-dependent attenuation of the dispersion compensating fiber and not for compensating chromatic dispersion or chromatic dispersion slope due to the dispersion compensating fiber. The type of line fiber used is not specified.

The invention proposes a solution to the problem of compensating chromatic dispersion and chromatic dispersion slope in broadband transmission systems. Compared with the above-mentioned Research Disclosure, it proposes a solution in which the Bragg grating remains easy to produce, in spite of the broad bandwidth of the system. The invention proposes a solution that is adapted to high data rate transmission, over broad bandwidths.

More precisely, the invention provides an optical fiber transmission system comprising a transmission fiber section (4₁, 4ₙ, 9₁, 9ₙ) compensated in chromatic dispersion by a dispersion compensating fiber section (12, 10₁, 10ₙ) and by a plurality of Bragg gratings (15, 16, 17, 20, 22, 24) each having a passband of width greater than or equal to 25 nm, and compensating chromatic dispersion in distinct wavelength bands. Said Bragg gratings may be connected in parallel and/or in series.

In an embodiment, each Bragg grating presents a passband of width greater than or equal to 30 nm, and preferably greater than or equal to 35 nm.

The absolute value of the chromatic dispersion accumulated in each Bragg grating is preferably less than or equal to 250 ps/nm.

It is also advantageous for each Bragg grating to compensate, for the center wavelength in its utilization range, less than two-thirds of the chromatic dispersion of the transmission fiber, and preferably less than one-third of the chromatic dispersion of the transmission fiber.

In an embodiment, each Bragg grating compensates, for the center wavelength of its utilization range, at least half the chromatic dispersion slope of the transmission fiber.

In another embodiment, each Bragg grating presents, for the center wavelength of its utilization range, a ratio of chromatic dispersion to chromatic dispersion slope having an absolute value greater than 15 nm, and preferably greater than 20 nm.

Advantageously, the dispersion compensating fiber presents chromatic dispersion of sign opposite to the transmission fiber at a utilization wavelength, and having an absolute value that is preferably greater than or equal to the dispersion of the transmission fiber.

In an embodiment, the utilization band of the system extends from above 1250 nm to below 1650 nm; it may comprise the S band in the range 1460 nm to 1490 nm, the C band in the range 1530 nm to 1565 nm, and/or the L band in the range 1570 nm to 1610 nm, each associated with a respective Bragg grating.

It is advantageous for the chromatic dispersion accumulated for each channel forming a part of the utilization wavelength band to be less than 100 ps/nm, and preferably less than 50 ps/nm or even 10 ps/nm on average over 100 km of transmission.

The invention also provides a chromatic dispersion compensation module for an optical fiber transmission system, the module comprising a dispersion compensating fiber section (12) and a plurality of Bragg gratings (15, 16, 17) each presenting a passband of width greater than or equal to 25 nm, and each compensating chromatic dispersion in a distinct wavelength band. Said Bragg gratings may be connected in series or in parallel.

The absolute value of the chromatic dispersion accumulated in each Bragg grating is preferably less than or equal to 250 ps/nm.

It is also advantageous for each Bragg grating to present a passband of width greater than or equal to 30 nm, and preferably greater than or equal to 35 nm.

In an embodiment, for a utilization wavelength, the chromatic dispersion accumulated in each Bragg grating is less than or equal to twice the chromatic dispersion accumulated in the dispersion compensating fiber, and is preferably less than half of it.

In another embodiment, for the center wavelength of the utilization range of each Bragg grating, the chromatic dispersion slope accumulated in the Bragg grating is negative and less than or equal to the chromatic dispersion slope accumulated in the dispersion compensating fiber.

It is also advantageous for each Bragg grating to present, for the center wavelength of its utilization range, a ratio of chromatic dispersion to slope that is greater than 15 nm, and preferably greater than 20 nm.

The utilization band preferably extends from above 1250 nm to below 1650 nm; it may comprise the S band in the range 1460 nm to 1490 nm, the C band in the range 1530 nm to 1565 nm, and the L band in the range 1570 nm to 1610 nm, each associated with a respective Bragg grating.

Finally, the invention provides a chromatic dispersion compensation module for an optical fiber transmission system, the module having a plurality of Bragg gratings each presenting a passband of width greater than equal to 25 nm, and compensating chromatic dispersion in distinct wavelengths bands.

The module may present a plurality of Bragg gratings connected in series and/or a plurality of Bragg gratings connected in parallel.

In all cases, using Bragg gratings makes it possible to limit the effects of the constraint on the ratio of chromatic dispersion to chromatic dispersion slope: this makes it possible to use a dispersion compensating fiber that presents propagation characteristics that are acceptable from a system point of view. Furthermore, the use of dispersion compensating fiber makes it possible to limit the chromatic dispersion which needs to be compensated by the Bragg gratings, thereby overcoming the constraint on bandwidth.

Other characteristics and advantages of the invention appear on reading the following description of embodiments of the invention, given by way of example and with reference to the accompanying drawings, in which:

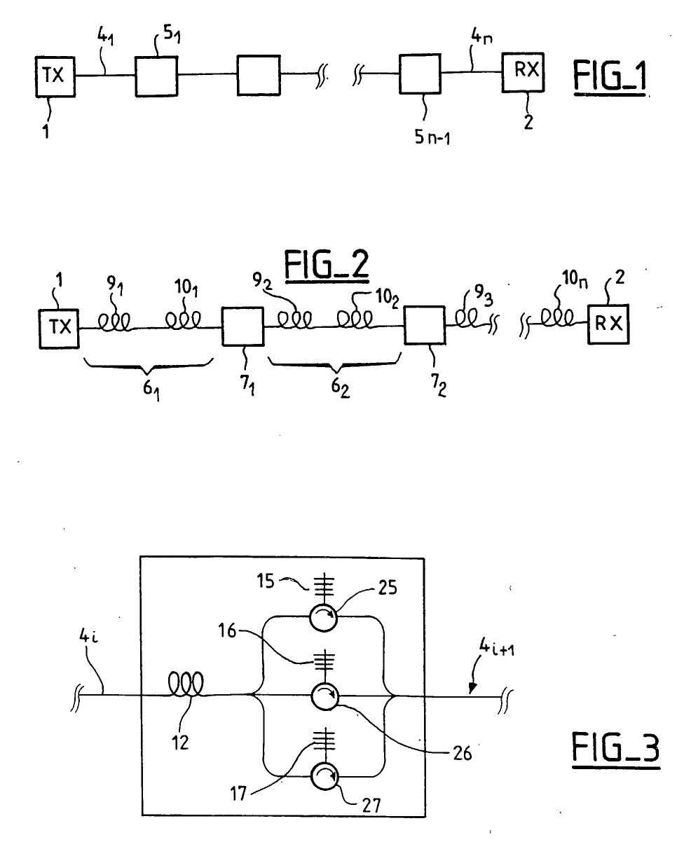

FIG. 1 is a diagram of a transmission system in accordance with the invention;

FIG. 2 is a diagram of another embodiment of a transmission system in accordance with the invention; and

FIGS. 3 to 5 show embodiments of dispersion compensation modules in accordance with the invention.

In the embodiment of FIG. 1, the line fiber is constituted by a so-called transmission fiber, i.e. SMF, NZ-DSF, or other fiber, and compensation is performed in a compensation module, i.e. a unit of small dimensions. In the embodiment of FIG. 2, in contrast, a portion of the dispersion compensation is performed in the cable; the term “line fiber” then covers both the transmission fiber (SMF, NZ-DSF, etc.) and the dispersion compensating fiber.

FIG. 1 shows a transmitter TX 1 and a receiver RX 2. These two elements are interconnected by a plurality of line fiber segments 4₁ to 4ₙ. The term “line fiber” is used herein to designate the fiber which extends along the transmission system, and is thus of a length which corresponds substantially to the length of the system. In the example of FIG. 1, this line fiber is constituted by a transmission fiber of NZ-DSF type, or of some other type. Dispersion compensation modules 5₁ to 5ₙ₋₁ are disposed between the segments. The figure does not show the filters, amplifiers, and other elements that have no direct effect on the operation of the invention. The dispersion compensation module 5₁ is shown in detail in FIG. 3. In this embodiment, all of the compensation of chromatic dispersion and of chromatic dispersion slope is performed within the modules.

FIG. 2 is a diagram of another embodiment of a transmission system of the invention. In the example of FIG. 2, the dispersion compensating fiber is also used as line fiber. As in FIG. 1, the transmission system has a transmitter TX 1 and a receiver RX 2. These two elements are interconnected by a plurality of segments of fiber 6₁ to 6ₙ, with dispersion compensation modules 7₁ to 7ₙ₋₁ being disposed between them. Between two dispersion compensation modules, each segment 6₁ presents a section of NZ-DSF or other transmission fiber 9ᵢ and a section of dispersion compensating fiber 10ᵢ. In other words, compared with the embodiment of FIG. 1, the line fiber is made up of sections of different fibers, presenting opposite chromatic dispersions.

In the examples of these two figures, it is also advantageous to provide a portion in the receiver RX that acts like a compensation module. More generally, it is possible to perform pre-compensation or post-compensation in the transmitter or in the receiver.

FIG. 3 shows an embodiment of a dispersion compensation module that is suitable for a transmission system of the type shown in FIG. 1 in which dispersion compensation is performed solely in the compensation modules 5_{1,n-1}. The signal travels along the dispersion compensating fiber 12 and is then demultiplexed; in this example, it is demultiplexed into three bands S, C, and L, it being understood that it would be equally possible to use other bands or a smaller number of bands. Each portion of the demultiplexed signal then passes through a corresponding branch; each branch presents a three-port circulator and a Bragg grating used in reflection: one port of the circulator is connected to the outlet of the dispersion compensating fiber, one port of the circulator is connected to the Bragg grating, and the third port of the circulator constitutes the outlet of the dispersion compensation module. The figure thus shows in each branch: a circulator 25, 26, 27; and a Bragg grating 15, 16, 17 operating in reflection. After being reflected in the corresponding Bragg grating and passing into the circulator, the signals in the three bands are remultiplexed or combined. In other words, the Bragg gratings compensate dispersion in different bands and they are connected in parallel. This case shows the flexibility provided by associating the DCF with the Bragg grating.

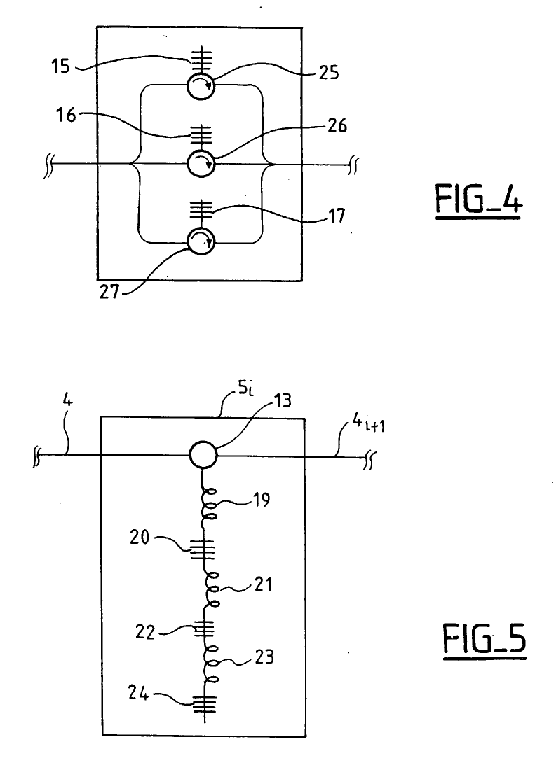

FIG. 4 is a diagram of a dispersion compensation module for the transmission system of FIG. 2. This module is similar to that of FIG. 3 except that it does not include the dispersion compensating fiber. The module thus presents only the three branches with their circulators 25, 26, 27 and their Bragg gratings 15, 16, and 17.

FIG. 5 shows another embodiment of a module, for use with a transmission system of the type shown in FIG. 1. A succession of dispersion compensating fibers and of Bragg gratings is used for the various bands. In other words, in the embodiment of FIG. 5, Bragg gratings compensating dispersion in different bands are connected in series. The example corresponds to the three bands S, C, and L, but in this case also, it would be possible to provide other bands. The module thus presents a single three-port circulator 13. One port of the circulator is connected to the inlet of the module, another port of the circulator is connected to the succession of dispersion compensating fibers and Bragg gratings, and the third port of the circulator constitutes the outlet of the dispersion compensation module. More specifically, the succession of fibers and of Bragg gratings comprises a first dispersion compensating fiber 19, a first Bragg grating 20, a second dispersion compensating fiber 21, a second Bragg grating 22, a third dispersion compensating fiber 23, and a third Bragg grating 24. Light entering the module travels via the circulator to be sent towards the Bragg gratings. Light in the first band passes through the first dispersion compensating fiber 19 and is reflected by the first Bragg grating 20. It passes back through the first compensating fiber 19 and the circulator to leave the dispersion compensation module. Light in the second band passes through the first dispersion compensating fiber 19, the first Bragg grating 20, the second dispersion compensating fiber 21, and is reflected by the second Bragg grating 22. It then passes back through the same component and the circulator to leave the dispersion compensation module. Finally, light in the third band passes through the first dispersion compensating fiber 19, the first Bragg grating 20, the second dispersion compensating fiber 21, the second Bragg grating 22, the third dispersion compensating fiber 23, and is reflected by the third Bragg grating 24. It then passes back through the same components and travels via the circulator to leave the dispersion compensation module. Thus, the wavelength-tuned Bragg gratings used in reflection serve to process the light in the various bands differently. It should also be observed at this point that the Bragg gratings may be induced in a single dispersion compensating fiber if its birefrigency makes that possible, thereby avoiding the losses that are generated by splices.

The embodiments of FIGS. 3, 4, and 5 can be combined by sharing the dispersion compensating fiber between the line fiber and the modules or by combining the Bragg gratings in more complex manner, mixing parallel and serial connections; the embodiments shown are merely extremes in a range of possible solutions.

Example implementations of the invention are given below.

### EXAMPLE 1

Dispersion and slope are compensated for the three wavelength bands S, C, and L using the principle shown in FIGS. 3 or 4. Numerical values are as follows:

the transmission fiber needing to be compensated:

a 100 km section of NZ-DSF+ presenting at respective wavelengths 1475 nm, 1550 nm, and 1590 nm, chromatic dispersion values of 3.6 ps/(nm.km), 8 ps/(nm.km), and 10.3 ps/(nm.km), and respective chromatic dispersion slope values of 0.061 ps/(nm².km), 0.058 ps/(nm².km), and 0.057 ps/(nm².km); and

accumulated chromatic dispersion at the three wavelengths over the NZ-DSF+ section of 360 ps/nm, 800 ps/nm, and 1030 ps/nm; and accumulated chromatic dispersion slope over the NZ-DSF+ section of 6.1 ps/nm², 5.8 ps/nm², and 5.7 ps/nm²;

the dispersion compensating fiber:

length: 7.2 km;

chromatic dispersion at the three wavelengths of −78.4 ps/(nm.km), −100 ps/(nm.km), and −113.5 ps/(nm.km) locally, giving accumulated values of −564.5 ps/nm, −720 ps/nm, and −817.2 ps/nm;

chromatic dispersion slope: −0.239 ps/(nm².km), −0.330 ps/(nm².km), and −0.335 ps/(nm².km) locally, giving accumulated values of −1.7 ps/nm², −2.4 ps/nm², and −2.4 ps/nm²;

the Bragg grating 15 seen by the channels in band S:

bandwidth 35 nm, length about 1 m;

chromatic dispersion at 1475 nm: +204.5 ps/nm;

chromatic dispersion slope: −4.4 ps/nm²;

ratio of chromatic dispersion to chromatic dispersion slope at 1475 nm for the Bragg grating: −46 nm;

the Bragg grating 16 seen by the channels in band C:

bandwidth 35 nm, length about 0.5 m;

chromatic dispersion at 1550 nm: −80 ps/nm;

chromatic dispersion slope: −3.4 ps/nm²;

ratio of chromatic dispersion to chromatic dispersion slope at 1550 nm for the Bragg grating: 24 nm;

the Bragg grating 17 seen by the channels in band L:

bandwidth 35 nm, length about 1 m;

chromatic dispersion at 1590 nm: −213 ps/nm;

chromatic dispersion slope: −3.3 ps/nm²;

ratio of chromatic dispersion to chromatic dispersion slope at 1590 nm for the Bragg grating: 65 nm.

The sums of the chromatic dispersion and of the chromatic dispersion slope at 1475 nm, 1550 nm, and 1590 nm as accumulated in the transmission fiber section, the dispersion compensating fiber, and the respective Bragg gratings are zero. This example can be used with the configurations shown in FIGS. 3 and 4.

### EXAMPLE 2

This example uses the same dispersion compensating and transmission fibers as in the preceding example. In this case, dispersion and slope compensation is performed for the three wavelength bands S, C, and L by using the principle shown in FIG. 5. The numerical values are as follows:

the transmission fiber needing to be compensated:

a 100 km section of NZ-DSF+ presenting at respective wavelengths 1475 nm, 1550 nm, and 1590 nm, chromatic dispersion values of 3.6 ps/(nm.km), 8 ps/(nm.km), and 10.3 ps/(nm.km), and respective chromatic dispersion slope values of 0.061 ps/(nm².km), 0.058 ps/(nm².km), and 0.057 ps/(nm².km); and

accumulated chromatic dispersion at the three wavelengths over the NZ-DSF+ section of 360 ps/nm, 800 ps/nm, and 1030 ps/nm; and accumulated chromatic dispersion slope over the NZ-DSF+ section of 6.1 ps/nm², 5.8 ps/nm², and 5.7 ps/nm²;

the dispersion compensating fiber:

length: 1.1 km of fiber 19 to the grating reflecting the channels in S band, then an additional 1.9 km of fiber 21 to the grating reflecting the channels in C band, and finally an additional 0.7 km of fiber 23 to the grating reflecting the channels in L band;

chromatic dispersion at the three wavelengths: −78.4 ps/(nm.km), −100 ps/(nm.km), and −113.5 ps/(nm.km) locally, i.e. −172.5 ps/nm, −600 ps/nm, and −840 ps/nm when accumulated (taking account of the go-and-return paths and the different lengths seen by each of the channels);

chromatic dispersion slope: −0.239 ps/(nm².km), −0.330 ps/(nm².km), and −0.335 ps/(nm².km) locally, i.e. giving accumulated values of −0.5 ps/nm², −2.0 ps/nm², and −2.5 ps/nm² (taking account of the go-and-return paths and of the different lengths seen by each of the channels);

the Bragg grating 20 seen by the channels in band S:

bandwidth 35 nm, length about 1 m;

chromatic dispersion at 1475 nm: −187.5 ps/nm;

chromatic dispersion slope: −5.6 ps/nm²;

ratio of chromatic dispersion to chromatic dispersion slope at 1475 nm for the Bragg grating: 33 nm;

the Bragg grating 22 seen by the channels in band C:

bandwidth 35 nm, length about 1 m;

chromatic dispersion at 1550 nm: −200 ps/nm;

chromatic dispersion slope: −3.8 ps/nm²;

ratio of chromatic dispersion to chromatic dispersion slope at 1550 nm for the Bragg grating: 53 nm;

the Bragg, grating 24 seen by the channels in band L:

bandwidth 35 nm, length about 1 m;

chromatic dispersion at 1590 nm: −190 ps/nm;

chromatic dispersion slope: −3.2 ps/nm²;

ratio of chromatic dispersion to chromatic dispersion slope at 1590 nm for the Bragg grating: 59 nm.

As before, the sums of chromatic dispersion and chromatic dispersion slope at the wavelengths of 1475 nm, 1550 nm, and 1590 nm as accumulated in the transmission fiber section, in the dispersion compensating fiber, and in the respective Bragg gratings are zero.

### EXAMPLE 3

This example uses the same configuration as in Example 1. The transmission fiber used in this case is SMF. The numerical values are as follows:

the transmission fiber needing to be compensated:

a 100 km section of SMF presenting at respective wavelengths 1475 nm, 1550 nm, and 1590 nm, chromatic dispersion values of 12.4 ps/(nm.km), 17 ps/(nm.km), and 19.3 ps/(nm.km), and respective chromatic dispersion slope values of 0.064 ps/(nm².km), 0.058 ps/(nm².km), and 0.056 ps/(nm².km); and

accumulated chromatic dispersion at the three wavelengths over the SMF section of 1240 ps/nm, 1700 ps/nm, and 1920 ps/nm; and accumulated chromatic dispersion slope over the SMF section of 6.4 ps/nm², 5.8 ps/nm², and 5.6 ps/nm²;

the dispersion compensating fiber:

length: 15 km;

chromatic dispersion at the three wavelengths of −78.4 ps/(nm.km), −100 ps/(nm.km), and −113.5 ps/(nm.km) locally, giving accumulated values of −1176 ps/nm, −1500 ps/nm, and −1702.5 ps/nm;

chromatic dispersion slope: −0.239 ps/(nm².km), −0.330 ps/(nm².km), and −0.335 ps/(nm².km) locally, giving accumulated values of −3.6 ps/nm², −5.0 ps/nm², and −5.0 ps/nm²;

the Bragg grating 15 seen by the channels in band S:

bandwidth 35 nm, length about 1 m;

chromatic dispersion at 1475 nm: −64 ps/nm;

chromatic dispersion slope: −2.8 ps/nm²;

ratio of chromatic dispersion to chromatic dispersion slope at 1475 nm for the Bragg grating: 23 nm;

the Bragg grating 16 seen by the channels in band C:

bandwidth 35 nm, length about 0.5 m;

chromatic dispersion at 1550 nm: −200 ps/nm;

chromatic dispersion slope: −0.8 ps/nm²;

ratio of chromatic dispersion to chromatic dispersion slope at 1550 nm for the Bragg grating: 250 nm;

the Bragg grating 17 seen by the channels in band L:

bandwidth 35 nm, length about 1 m;

chromatic dispersion at 1590 nm: −217.5 ps/nm;

chromatic dispersion slope: −0.6 ps/nm²;

ratio of chromatic dispersion to chromatic dispersion slope at 1590 nm for the Bragg grating: 363 nm.

The sums of the chromatic dispersion and chromatic dispersion slope at the wavelengths of 1475 nm, 1550 nm, and 1590 nm, as accumulated in the transmission fiber, the dispersion compensating fiber, and the respective Bragg gratings are zero. The configurations shown in FIGS. 3 and 4 can be used with this example.

Naturally, the present invention is not limited to the examples and embodiments as described as shown, and the invention can be varied in numerous ways by the person skilled in the art. Module or system configurations other than those shown in FIGS. 1 to 5 are possible. In particular, it is possible to envisage using other types of Bragg grating, such as reflection Bragg gratings presenting pitch variation that is more complex than quadratic variation, Bragg gratings with mode coupling, or Bragg gratings connected for use in transmission.

1/ An optical fiber transmission system comprising a transmission fiber section (4₁, 4ₙ, 9₁, 9ₙ) compensated in chromatic dispersion by a dispersion compensating fiber section (12, 10₁, 10ₙ) and by a plurality of Bragg gratings (15, 16, 17, 20, 22, 24) each having a passband of width greater than or equal to 25 nm, and compensating chromatic dispersion in distinct wavelength bands.

2/ The system of claim 1, characterized in that said Bragg gratings (20, 22, 24) are connected in series.

3/ The system of claim 1, characterized in that said Bragg gratings (15, 16, 17) are connected in parallel.

4/ The system of any one of claims 1 to 3, characterized in that each Bragg grating presents a passband of width greater than or equal to 30 nm, preferably greater than or equal to 35 nm.

5/ The system of any one of claims 1 to 4, characterized in that the absolute value of the chromatic dispersion accumulated in each Bragg grating is less than or equal to 250 ps/nm.

6/ The system of any preceding claim, characterized in that each Bragg grating compensates, at the center wavelength of its utilization range, less than two-thirds of the chromatic dispersion of the transmission fiber, and preferably less than one-third of the chromatic dispersion of the transmission fiber.

7/ The system of any preceding claim, characterized in that the Bragg grating compensates, for the center wavelength of its utilization range, at least half of the chromatic dispersion slope of the transmission fiber.

8/ A system of any preceding claim, characterized in that the Bragg grating presents, for the center wavelength of its utilization range, a ratio of chromatic dispersion to chromatic dispersion slope having an absolute value greater than 15 nm, preferably greater than 20 nm.

9/ A system of any preceding claim, characterized in that the dispersion compensating fiber presents chromatic dispersion of sign opposite to the transmission fiber for a utilization wavelength, and of absolute value that is preferably greater than or equal to the absolute value of the dispersion of the transmission fiber.

10/ The system of any preceding claim, characterized in that the utilization band extends from above 1250 nm to below 1650 nm.

11/ The system of any preceding claim, characterized in that the utilization band comprises the S band in the range 1460 nm to 1490 nm, the C band in the range 1530 nm to 1565 nm, and the L band in the range 1570 nm to 1610 nm, each associated with a respective Bragg grating.

12/ The system of any one of claims 1 to 11, characterized in that the chromatic dispersion accumulated for each channel forming part of the utilization wavelength band is less than 100 ps/nm, and preferably less than 50 ps/nm, or indeed 10 ps/nm, on average for 100 km of transmission.

13/ A chromatic dispersion compensation module for an optical fiber transmission system, the module comprising a dispersion compensating fiber section (12) and a plurality of Bragg gratings (15, 16, 17) each presenting a passband of width greater than or equal to 25 nm, and each compensating chromatic dispersion in a distinct wavelength band.

14/ The module of claim 13, characterized in that said Bragg gratings are connected in series.

15/ The module of claim 13, characterized in that said Bragg gratings are connected in parallel.

16/ The module of any one of claims 13 to 15, characterized in that the absolute value of the chromatic dispersion accumulated in each Bragg grating is less than or equal to 250 ps/nm.

17/ The module of any one of claims 13 to 16, characterized in that each Bragg grating presents a passband of width greater than or equal to 30 nm, preferably greater than or equal to 35 nm.

18/ The module of any one of claims 13 to 17, characterized in that, for a center wavelength of its utilization range, the chromatic dispersion accumulated in each Bragg grating is less than or equal to twice the chromatic dispersion accumulated in the dispersion compensating fiber (12), and preferably less than half of it.

19/ The module of any one of claims 13 to 18, characterized in that, for the center wavelength of the utilization range of each Bragg grating, the chromatic dispersion slope accumulated in the Bragg grating is negative and less than or equal to the chromatic dispersion accumulated in the dispersion compensating fiber (12).

20/ The module of any one of claims 13 to 19, characterized in that each Bragg grating presents, for the center wavelength of its utilization range, a ratio of chromatic dispersion to chromatic dispersion slope having an absolute value greater than 15 nm, and preferably greater than 20 nm.

21/ The module of any one of claims 13 to 20, characterized in that the utilization band extends from above 1250 nm to below 1650 nm.

22/ The module of any one of claims 13 to 21, characterized in that the utilization band comprises the S band in the range 1460 nm to 1490 nm, the C band in the range 1530 nm to 1565 nm, and the L band in the range 1570 nm to 1610 nm, each associated with a respective Bragg grating.

23/ A chromatic dispersion compensation module for an optical fiber transmission system, the module comprising a plurality of Bragg gratings (14, 15, 16, 17) each presenting a passband of width greater than or equal to 25 nm, and compensating chromatic dispersion in distinct wavelength bands.

24/ The module of claim 23, characterized in that said Bragg grating are connected in series.

25/ The module of claim 23, characterized in that said Bragg grating are connected in parallel.
